(19) United States
(12) Patent Application Publication
(10) Pub. No.: US 2019/0114635 A1
(43) Pub. Date: Apr. 18, 2019

(54) Computer System and Computer-Implemented Method for Processing a Payment Transaction

(71) Applicant: MASTERCARD INTERNATIONAL INCORPORATED, Purchase, NY (US)

(72) Inventor: Arunmurthy Gurunathan, Pune (IN)

(21) Appl. No.: 16/141,316

(22) Filed: Sep. 25, 2018

(30) Foreign Application Priority Data
Oct. 16, 2017 (SG) 10201708525Q

(51) Int. Cl. G06Q 20/40; G06Q 20/08; G06Q 20/32

(52) U.S. Cl. CPC G06Q 20/4014; G06Q 20/0855; G06Q 20/385; G06Q 20/4012; G06Q 20/40145; G06Q 20/3224

(57) ABSTRACT

In one aspect, a payment network server for processing a payment transaction initiated by a third party is described, the server comprises at least a computer processor and a data storage device, the data storage device comprising non-transitory instructions operative by the processor to: (i) receive, from a merchant server, a payment transaction request comprising transaction details and a transaction indicator, the transaction details comprising a customer identifier and a payment amount, the transaction indicator giving indication to proceed; (ii) query a payment network database associating issuer institutions with a plurality of customer identifiers to identify an issuer institution and an associated issuer server; (iii) request authorisation, from at least one of the issuer server and the customer, to proceed with the payment transaction; and (iv) transmit, to the merchant server, a payment transaction response indicating an approval or a refusal for the payment transaction to proceed.

### FIELD OF THE INVENTION

The present invention relates to a computer system and computer-implemented method for processing a payment transaction, in particular, for processing a payment transaction with improved security to minimise fraud.

### BACKGROUND OF THE INVENTION

Payment for goods and services using payment cards has been on the rise in recent years. According to a World Payment Report, payment transactions using payment cards were estimated to form 65% of global non-cash payment transactions in 2014, in the numbers of 277-billion transactions. The ubiquitous use of payment cards may be a result of an enhanced customers' experience. For example, use of a payment card in payment transactions reduces the need to obtain and secure cash, and enables customers to enjoy various promotions associated with card payments.

Despite all the advantages of payment card transactions, there are a number of drawbacks. A prevalent problem faced by card owners is fraudulent use. Coupled with an extensive use of payment card details (e.g. entering personal identification number (PIN) or password) for payment card transactions is a risk that these details may be compromised. The compromised payment card details may then be used for subsequent fraudulent payment card transactions without the knowledge and authorisation of the card owner.

At present, the most common form of validation for payment card transactions is authentication using a PIN or a signature for physical card transactions, or a card verification code (CVC2 or CVV2) associated with a payment card for card-not-present transactions. Nonetheless, a PIN or a signature may easily be compromised or copied, and if the payment card is stolen, the CVC2 or CVV2 associated with the payment card is also available to the thief as it is printed on the payment card itself. As such, these forms of validation may not provide adequate security measures for payment card transactions.

Moreover, a card owner is typically required to actively block the use of a payment card when the payment card or its identity is stolen. If the card owner is unaware that the payment card or its identity is stolen, the chances of the stolen card being fraudulently used is very high. This may result in a financial loss to the card owner.

It is therefore an aim of the present invention to provide a computer system and computer-implemented method to improve security and to reduce the risk of fraud in relation to payment card transactions.

### SUMMARY OF THE INVENTION

In general terms, the present disclosure proposes a computer system and computer-implemented method for processing payment transactions using a transaction indicator. The transaction indicator indicates that a payment transaction should proceed using a customer identifier and a payment amount—both of which are typically comprised in transaction details associated with a payment transaction.

In a first aspect of the present invention, there is provided a payment network server for processing a payment transaction initiated by a third party other than a customer when the customer is not present. The server comprises at least a computer processor and a data storage device, the data storage device comprising instructions operative by the processor to:

receive, from a merchant server, a payment transaction request, the payment transaction request comprising transaction details and a transaction indicator, the transaction details comprising a customer identifier provided by the third party and associated with a customer for the payment transaction and a payment amount;
query a payment network database associating issuer institutions with a plurality of customer identifiers to identify using the customer identifier an issuer institution and an associated issuer server;
request authorisation, from at least one of the issuer server and the customer, to proceed with the payment transaction; and
transmit, to the merchant server, a payment transaction response indicating an approval or a refusal for the payment transaction to proceed;
wherein the transaction indicator indicates that the payment transaction is to proceed using the customer identifier and the payment amount.

In this way, the computer system and computer-implemented method provide convenience with improved security for payment transactions by requiring simply a customer identifier and a payment amount to process a payment transaction. In other words, no signature, PIN, CVC2 etc. is required for the transaction to proceed and therefore the risk of such sensitive information being stolen for fraudulent use is minimised. The authorisation processes (see detailed description below) improve the security of the payment transactions, yet at the same time, enable friends/relatives of a customer to tap on the resources of the customer with the customer's approval. This advantageously provides friends/relatives of the customer with immediate financial help when necessary.

In an embodiment, where information other than a customer identifier and a payment amount, such as a card verification code (CVC2) and a card expiry date, is not comprised in the transaction details, the server is configured to substitute the information using dummy values.

In an embodiment, the server is configured to:

transmit, to a customer electronic device, an authentication request seeking an approval by the customer to authenticate the payment transaction; and
receive, from the customer electronic device, an authentication response indicating whether the payment transaction is authenticated;
wherein the customer electronic device is identified using the customer identifier, and wherein the payment transaction proceeds if the payment transaction is authenticated.

In an embodiment, the server is configured to:

transmit, to the issuer server, an authorisation request seeking an approval by the issuer server to authorise the payment transaction; and
receive, from the issuer server, an authorisation response indicating if the payment transaction is approved or refused to proceed, wherein the authorisation response indicates an approval for the payment transaction to proceed if the payment transaction is authenticated by the customer via a customer electronic device, and wherein the transaction indicator comprised in the authorisation request prompts the issuer server to seek authentication from the customer.

In an embodiment, the server is configured to:

determine if the customer identifier is a customer payment card account identifier; and
request authorisation from at least one of the issuer server and the customer to proceed with the payment transaction if the customer identifier is a customer payment card account identifier.

In an embodiment, where the customer identifier is a personal identifier other than a customer payment card account identifier, the server is configured to:

determine, using the payment network database, if the customer identifier is associated with more than one issuer institutions;
query, the payment network database, to determine if the customer identifier is associated with an institution priority preference, the institution priority preference comprises a ranked list of the more than one issuer institutions for use in the payment transaction; and
identify an issuer institution to process the payment transaction if it is determined that the customer identifier is associated with the institution priority preference.

In an embodiment, where the customer identifier is not associated with the institution priority preference, the server is configured to:

transmit, to the customer electronic device or the merchant server, a selection request requiring the customer or the third party to select one of the issuer institutions associated with the customer identifier for processing the payment transaction if the customer identifier is associated with more than one issuer institutions; and

receive, from the customer electronic device or the merchant server, a selection response indicating the issuer institution for processing the payment transaction.

In an embodiment, the server is configured to:

determine, using the payment network database, if the customer identifier is associated with more than one customer payment card accounts, each of the customer payment card account being maintained by the issuer institution;
query the payment network database to identify the customer payment card account associated with the customer identifier if it is determined that the customer identifier is not associated with more than one customer payment card accounts; and
request authorisation from at least one of the issuer server and the customer to proceed with the payment transaction.

In an embodiment, where the customer identifier is associated with more than one customer payment card accounts, the server is configured to:

query, the payment network database, to determine if the customer identifier is associated with an account priority preference, the account priority preference comprises a ranked list of customer payment card accounts associated with the customer identifier; and
identify a customer payment card account for use in the payment transaction if it is determined that the customer identifier is associated with the account priority preference.

In an embodiment, where the customer identifier is not associated with the account priority preference, the server is configured to:

transmit, to the customer electronic device or the merchant server, an account selection request requiring the customer or the third party to select one of the customer payment card accounts associated with the customer identifier for processing the payment transaction; and
receive, from the customer electronic device or the merchant server, an account selection response indicating the customer payment card account for processing the payment transaction.

In a second aspect of the present invention, there is described a computerised network for processing a payment transaction. The network comprises:

the payment network server according to the first aspect of the invention;

a customer electronic device; and
a customer wearable device, the customer wearable device being associated with the customer electronic device; and
wherein the customer wearable device is configured to disable the customer electronic device for carrying out the payment transaction if the customer wearable device is more than a pre-determined distance away from the customer electronic device.

In an embodiment, where the customer electronic device is communicatively connected to the customer wearable device, the payment network server is configured to communicate an authentication of the payment transaction to the customer wearable device or the customer electronic device or both.

The pre-determined distance may be determined by the customer via the customer electronic device or the customer wearable device.

In a third aspect of the present invention, there is described a computer-implemented method for processing a payment transaction initiated by a third party other than a customer when the customer is not present. The method comprises:

receiving, from a merchant server, a payment transaction request, the payment transaction request comprising transaction details and a transaction indicator, the transaction details comprising a customer identifier provided by the third party and associated with a customer for the payment transaction and a payment amount;
querying a payment network database associating issuer institutions with a plurality of customer identifiers to identify using the customer identifier an issuer institution and an associated issuer server;
requesting authorisation, from at least one of the issuer server and the customer, to proceed with the payment transaction; and
transmitting, to the merchant server, a payment transaction response indicating an approval or a refusal for the payment transaction to proceed;
wherein the transaction indicator indicates that the payment transaction can proceed using the customer identifier and the payment amount.

In an embodiment, where information other than a customer identifier and a payment amount, such as a card verification code (CVC2) and a card expiry date, is not comprised in the transaction details, the method further comprises substituting the information using dummy values.

In an embodiment, the method comprises:

transmitting, to a customer electronic device, an authentication request seeking an approval by the customer to authenticate the payment transaction; and
receiving, from the customer electronic device, an authentication response indicating whether the payment transaction is authenticated;
wherein the customer electronic device is identified using the customer identifier, and wherein the payment transaction proceeds if the payment transaction is authenticated.

In an embodiment, the method comprises:

transmitting, to the issuer server, an authorisation request seeking an approval by the issuer server to authorise the payment transaction; and
receiving, from the issuer server, an authorisation response indicating if the payment transaction is approved or refused to proceed, wherein the authorisation response indicates an approval for the payment transaction to proceed if the payment transaction is authenticated via a customer electronic device, wherein the authentication of the payment transaction is initiated by the issuer server.

The step of authenticating the payment transaction may comprise verifying a customer authentication identifier, the customer authentication identifier may be selected from one of the following: a personal identification number (PIN), a signature, a biometric identifier, a gesture, a specific voice command or a one-time password (OTP).

In an embodiment, the method comprises:

determining if the customer identifier is a customer payment card account identifier; and
request authorisation from at least one of the issuer server and the customer to proceed with the payment transaction if the customer identifier is a customer payment card account identifier.

In an embodiment, where the customer identifier is a personal identifier other than a customer payment card account identifier, the method comprises:

determining, using the payment network database, if the customer identifier is associated with more than one issuer institutions;
querying, the payment network database, to determine if the customer identifier is associated with an institution priority preference, the institution priority preference comprises a ranked list of the more than one issuer institutions for use in the payment transaction; and
identifying an issuer institution to process the payment transaction if it is determined that the customer identifier is associated with the institution priority preference.

In an embodiment, where the customer identifier is not associated with the institution priority preference, the method comprises:

transmitting, to the customer electronic device or the merchant server, a selection request requiring the customer or the third party to select one of the issuer institutions associated with the customer identifier for processing the payment transaction if the customer identifier is associated with more than one issuer institutions; and
receiving, from the customer electronic device or the merchant server, a selection response indicating the issuer institution for processing the payment transaction.

In an embodiment, the method comprises:

determining, using the payment network database, if the customer identifier is associated with more than one customer payment card accounts, each of the customer payment card account being maintained by the issuer institution;
querying the payment network database to identify the customer payment card account associated with the customer identifier if it is determined that the customer identifier is not associated with more than one customer payment card accounts; and
request authorisation from at least one of the issuer server and the customer to proceed with the payment transaction.

In an embodiment, where the customer identifier is associated with more than one customer payment card accounts, the method comprises:

querying, the payment network database, to determine if the customer identifier is associated with an account priority preference, the account priority preference comprises a ranked list of customer payment card accounts associated with the customer identifier; and
identifying a customer payment card account for use in the payment transaction if it is determined that the customer identifier is associated with the account priority preference.

In an embodiment, where the customer identifier is not associated with the account priority preference, the method comprises:

transmitting, to the customer electronic device or the merchant server, an account selection request requiring the customer or the third party to select one of the customer payment card accounts associated with the customer identifier for processing the payment transaction; and
receiving, from the customer electronic device or the merchant server, an account selection response indicating the customer payment card account for processing the payment transaction.

A computer-implemented method for processing a payment transaction initiated by a third party other than a customer when the customer is not present, the method comprising:

receiving, from a merchant server, a payment transaction request, the payment transaction request comprising transaction details and a transaction indicator, the transaction details comprising a customer identifier provided by the third party and associated with a customer for the payment transaction and a payment amount;
substituting information not comprised in the transaction details, such as a card verification code (CVC2) and a card expiry date, with dummy values;
determining, using a payment network database associating issuer institutions with a plurality of customer identifiers, if the customer identifier is a customer payment card account identifier;
determining, using the payment network database, whether the customer identifier is associated with more than one issuer institutions if the customer identifier is not a customer payment card account identifier;
querying the payment network database to identify using the customer identifier an issuer institution and an associated issuer server if the customer identifier is not associated with more than one issuer institutions;
determining, using the payment network database, whether the customer identifier is associated with more than one customer payment card accounts, each of the customer payment card accounts being maintained by the issuer institution;
querying the payment network database to identify the customer payment card account associated with the customer identifier if it is determined that the customer identifier is not associated with more than one customer payment card accounts;
transmitting, to the issuer server, an authorisation request seeking an approval by the issuer institution to authorise the transaction request, wherein the authorisation request comprises at least the transaction indicator, the customer payment card account identified using the payment network database and the payment amount;
receiving, from the issuer server, an authorisation response indicating an approval or a refusal for the payment transaction to proceed; and
transmitting, to the merchant server, a payment transaction response indicating an approval or a refusal for the payment transaction to proceed;
wherein the transaction indicator indicates that the payment transaction can proceed using the customer identifier and the payment amount;
wherein the transaction indicator comprised in the authorisation request prompts the issuer server to seek authentication from the customer via a customer electronic device to approve the payment transaction, the customer electronic device being identified using the customer identifier; and
wherein the customer electronic device is associated with a customer wearable device, the customer wearable device being configured to disable the customer electronic device for carrying out a payment transaction if the customer wearable device is more than a pre-determined distance away from the customer electronic device.

In a fifth aspect of the present invention, there is provided a non-transitory computer-readable medium having stored thereon program instructions for causing at least one processor to perform the method according to the third and fourth aspect of the invention.

Thus, the computer system and computer-implemented method provide convenience with improved security for payment transactions by requiring simply a customer identifier and a payment amount to process a payment transaction. Moreover, the present invention builds on existing infrastructures, providing steps for submitting information which is not available for the transaction using dummy values and requesting authentication of the payment transaction from a customer associated with the customer identifier remotely, thereby providing additional security measures with easy implementations and minimized set-up costs. Furthermore, a third party other than the customer (e.g. friends and/or relatives of the customer) may be able to use a customer's account in case of emergency, by simply providing the customer identifier and contacting the customer to authenticate the payment transaction through his/her electronic device to proceed with the payment transaction. Additionally, customers are not required to block stolen payment cards actively in a timely manner to prevent fraudulent use of the stolen payment cards since payment transactions would be further authenticated by the customer. This advantageously provides more confidence for customers and minimizes loss due to fraudulent use of stolen payment cards.

Other desirable features and characteristics will become apparent from the subsequent detailed description and the appended claims, taken in conjunction with the accompanying drawings of the disclosure. Moreover, within the scope of this proposed disclosure it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

Non-limiting embodiments of the invention will now be described for the sake of example only, with reference to the following drawings in which:

FIG. 1 shows a computerised network for processing payment transaction using a transaction indicator in accordance with a first embodiment of the invention;

FIG. 2 shows the steps of a method for processing payment transaction using a transaction indicator in accordance with an embodiment of the invention, and which may be performed by a server comprised in the computerised network of FIG. 1;

FIG. 3 shows additional steps to the method of FIG. 2 which may be performed by the server of FIG. 1 in accordance with an embodiment of the invention;

FIG. 4 shows additional steps to the method of FIG. 2 which may be performed by the server in accordance with an embodiment of the invention;

FIG. 5 shows additional steps which may be performed by the server in accordance with an embodiment of the invention;

FIG. 6 shows additional steps to the method of FIG. 5 which may be performed by the server in accordance with an embodiment of the invention;

FIG. 7 shows additional steps to the method of FIG. 5 which may be performed by the server in accordance with an embodiment of the invention;

FIG. 8 shows steps of a method for processing a payment transaction initiated by a third party other than a customer in accordance with an embodiment of the invention;

FIG. 9 shows schematically the structure of a server which may be used in the computerised network of FIG. 1 to implement a method in accordance with embodiments of the invention;

FIG. 10 shows schematically the structure of a communication device which may be used in the computerised network of FIG. 1 to implement a method in accordance with embodiments of the invention; and

FIG. 11 shows schematically the structure of the payment network server which may be used in the computerised network of FIG. 1 to carry out the methods of FIGS. 2 to 7 in accordance with an embodiment of the invention.

### DETAILED DESCRIPTION OF THE EMBODIMENT

As used herein, the term “account” refers to any form of arrangement that a customer has with an institution that allows the customer to deposit and/or withdraw funds. An account can be a deposit account, a credit card account, a debit card account, a current account, a saving account, an overdraft account, an electronic wallet account or any other type of account offered by the institution. Furthermore, the account may be a loan account in which case the customer owes money to the institution. In some embodiments, an account may be associated with a payment card, such as a credit card, a debit card, a prepaid card, a charge card, a membership card, a promotional card, a frequent flyer card, an identification card, a prepaid card, a gift card, and/or any other device that may hold account information, such as mobile phones, smartphones, personal digital assistants (PDAs), key fobs, transponder devices, NFC-enabled devices, and/or computers.

The term “institution” is not necessarily limited to organizations which are legally constituted as banks, since in some jurisdictions other organizations may be permitted to maintain accounts. For example, an institution associated with an acquirer or an issuer can be one of the following: a bank, a financial technology company, or a financial institution.

The term “transaction indicator” refers to a string or a portion comprising at least one of an alphanumeric, a flag or a symbol which indicates that a payment transaction can be processed using a customer identifier and a payment amount as minimum data required.

The terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Moreover, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

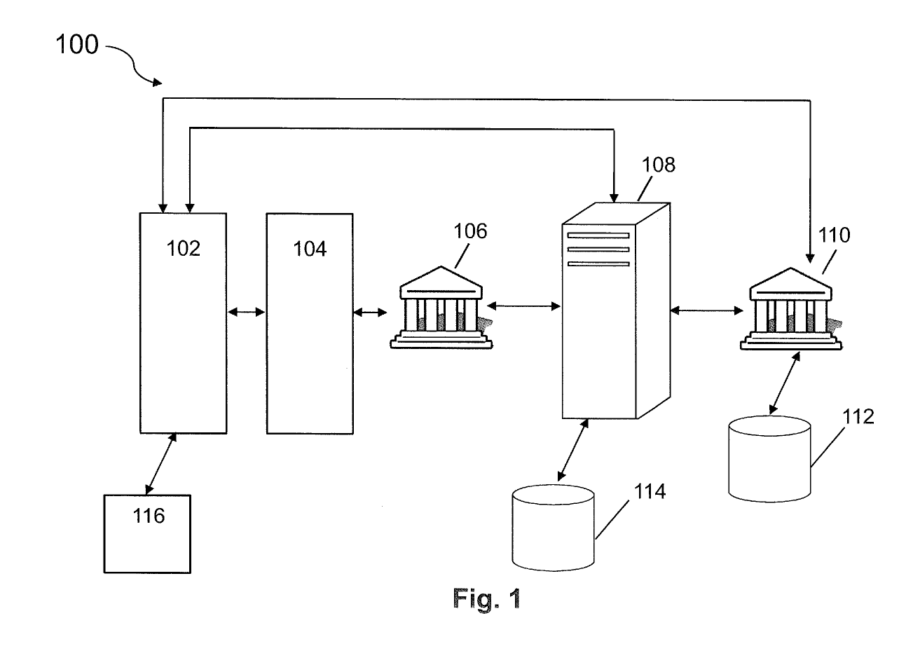

Referring to FIG. 1, an example of a computerised network 100 is shown. The computerised network 100 comprises a payment network server 108 which facilitates a payment transaction between a customer (e.g. a payment card holder or an account holder) and a merchant which receives the funds. In some embodiments, the payment transaction is between a third party (e.g. friends or relatives of a payment card holder or an account holder) associated with the customer (i.e. the payment card holder or the account holder) and the merchant. The payment network server 108 is a server associated with a payment network. As shown in FIG. 1 the payment network server 108 is coupled to an acquirer server 106 and an issuer server 110. The issuer server 110 is a server associated with an issuer institution. The issuer institution is authorised by the payment network to issue payment cards on behalf of customers to perform transactions over the payment network. The issuer institution may also maintain an account associated with the customer through which funds can be transferred. The issuer institution also provides funds, via the payment network, for transactions that have been approved. The acquirer server 106 is operated by an acquirer institution at which the merchant maintains an account to receive funds. The acquirer server 106 may be associated with a payment gateway as part of a merchant service which is provided by an e-commerce application service provider that authorizes credit card or direct payments processing for e-businesses, online retailers etc. Although only one acquirer server 106 and only one issuer server 110 are shown in FIG. 1, a plurality of acquirer servers 106 operated by respective acquirer institutions and/or a plurality of issuer servers 110 operated by respective issuer institutions may also form part of the computerised network 100. Similarly, a plurality of customer electronic devices 102 and/or a plurality of merchant servers 104 may also form part of the computerised network 100 although only one customer electronic device 102 and only one merchant server 104 are shown in FIG. 1. Moreover, an issuer database 112 and a payment network database 114 are operationally connected to the issuer server 110 and the payment network server 108 respectively. The issuer database 112 serves at least to store information associated with a payment card issued by the issuer institution or a customer payment card account maintained at the issuer institution. The issuer database 112 may store data in regards to transactions associated with the payment card or the customer payment card account. The issuer database 112 may also store personal details associated with the customer of the customer payment card account, for example, a customer mobile number, a customer electronic mail address or a customer physical address. The payment network database 114 serves at least to store data in regards to transactions processed by the payment network server 108. The payment network database 114 may store information used for associating issuer institutions with a plurality of customer identifiers to identify, using a customer identifier, an issuer institution and an associated issuer server. In embodiments where the customer identifier is associated with more than one issuer institutions, the payment network database 114 stores information associated with an institution priority preference of the more than one issuer institutions. The institution priority preference may comprise a pre-determined list of the more than one issuer institutions ranked (by the customer) in order of preference for processing payment transactions using a transaction indictor. The payment network database 114 may store information used for determining if the customer identifier is associated with more than one customer payment card accounts for the issuer institution. The payment network database 114 may also store information associated with an account priority preference of the more than one customer payment card accounts if the customer identifier is associated with more than one customer payment card accounts for the issuer institution. The account priority preference may comprise a list of the more than one customer payment card accounts ranked (by the customer) in order of preference for use in payment transactions using a transaction indictor. Moreover, the payment network database 114 may store information relating to customers, acquirer institutions and/or issuer institutions registered with the payment network server for processing payment transactions using a transaction indicator. Communication between the servers 104, 106, 108, 110 and databases 112, 114 may take place via any type of network, for example, a virtual private network (VPN), the Internet, a local area and/or wide area network (LAN and/or WAN), and so on. In addition, a customer wearable device 116 associated with the customer electronic device 102 may form part of the computerised network 100. The customer wearable device 116 may be configured to disable the customer electronic device 102 for carrying out a payment transaction if the customer wearable device 116 is more than a pre-determined distance away from the customer electronic device 102. The pre-determined distance may be determined by the customer via the customer electronic device 102 or the customer wearable device 116.

The customer electronic device 102 may be a mobile phone, a smart device, a personal computer, a tablet, a laptop, a key-fob or a personal digital assistant (PDA). In embodiments of the present invention, the customer electronic device 102 primarily functions as a means for authenticating a payment transaction by the customer in which a customer payment card account or any account is used. Advantageously, no specific application (“App”) is required to be installed in the customer electronic device 102 before it can be used in embodiments of the present invention. Nevertheless, the present invention may also work with an App for use with the customer electronic device 102, in particular if a customer wearable device 116 is to be communicatively linked to the customer electronic device 102. In embodiments, the customer electronic device 102 may be configured to communicate with the issuer server 110 such that the issuer server 110 may determine the geo-location of the customer electronic device 102. The issuer server 110 may track the geo-location of the customer electronic device 102 via the App. The App of the customer electronic device 102 may be specific for use in processing transactions associated with a particular issuer institution or it may be a generic app that is able to process transactions associated with various issuer institutions. In any case, the App may be configured to assign a unique customer identification to the customer. Different payment cards or customer payment card accounts associated with the customer may be associated with the unique customer identification. Moreover, the App which may be configured to track a current location of the customer electronic device 102 so as to display appropriate options specific to the current location (e.g. an ATM or a POS transaction) to the customer.

A payment transaction can be initiated by a customer or a third party (a party associated with the customer e.g. a friend or a relative of the customer) at a point-of-sale (POS) terminal or at an e-commerce platform of a merchant via a customer electronic device 102, where the customer or the third party can select products desired to be purchased. Note that the term “product” is used in this document to include any of physical objects, data products (such as music or software) or services. Once the customer or the third party has confirmed the desired products for purchase, he/she is generally prompted to select a mode of payment to complete the payment transaction. Typically, if the customer or the third party chooses to use a payment card, he/she would need to present a physical copy of the payment card at the POS terminal. The customer or the third party may also be required to provide an authorised signature or a personal identification number (PIN) to proceed with the payment transaction. Alternatively, for card-not-present transactions, the customer or the third party may be prompted to enter payment card details and a delivery address. The payment card details typically comprise an indication of a payment card number, an expiry date and a card verification code (CVC2) associated with a payment card for the card-not-present transaction. The payment card details may also comprise a payment card type. However in embodiments of the present invention, the customer or the third party is required to provide simply a customer identifier for the payment transaction (e.g. a card-not-present transaction) to proceed. The customer identifier may be in the form of a mobile number, a credit card number, an address, an electronic mail address, a name, a security number, an identity card (IC) number or any other form of identification which can serve to uniquely identify the card holder or account owner. In an embodiment, the customer or the third party also provides information of a payment network (e.g. MasterCard® or VISA®) which is to be used for the payment transaction. This information may be provided at the POS terminal or at an e-commerce platform associated with a merchant server 104 when the payment transaction is initiated.

The merchant server 104, which is configured to process payment transactions using a customer identifier, then generates a payment transaction request comprising transaction details and a transaction indicator. The transaction details comprise the customer identifier associated with the customer for the payment transaction and a payment amount. The transaction indicator indicates that the payment transaction can proceed using only the customer identifier and the payment amount. Moreover, the merchant server 104 may be configured to provide dummy values in fields typically comprised in transaction details, such as a card verification code (CVC2) and a card expiry date, if the information associated with these fields are not provided for the payment transaction.

The acquirer server 106 is configured to receive the payment transaction request from the merchant server 104. The acquirer server 106 then routes the transaction authorisation request from the merchant server 104 to the payment network server 108, the payment network server 108 being associated with the payment network identified by the customer when the payment transaction was initiated. In some embodiments, the acquirer server 106 may share a transaction request location (e.g. a point-of-sale terminal (POS) or an internet protocol (IP) address for an e-commerce transaction) from which the payment transaction request is received with the issuer server 110. The transaction request location may be communicated to the issuer server 110 via the payment network server 108.

The payment network server 108 is configured to receive the payment transaction request from the acquirer server 106. The payment network server 108 is configured to carry out a number of processes before requesting authorisation for the payment transaction. In embodiments, the transaction indicator comprised in the payment transaction request prompts the payment network server 108 to carry out these processes. In particular, the payment network server 108 may be configured to determine, using the payment network database 114, if the customer identifier is a customer payment card account identifier. The customer payment card account identifier is associated with a customer payment card account maintained by the issuer institution. In an embodiment, where it is determined by the payment network server 108 that the customer identifier is the customer payment card account identifier, the payment network server 108 is configured to proceed with requesting authorisation from at least one of the issuer server and the customer to proceed with the payment transaction.

In an embodiment, where it is determined by the payment network server 108 that the customer identifier is a personal identifier other than a customer payment card account identifier, the payment network server 108 is configured to determine, using the payment network database 114, whether the customer identifier is associated with more than one issuer institutions. If it is determined that the customer identifier is associated with more than one issuer institutions, the payment network server 108 may be configured to query the payment network database 114 for an institution priority preference for the issuer institutions, and to identify a preferred issuer institution associated with the customer identifier. The institution priority preference may comprise ranking the issuer institutions associated with the customer identifier in order of a preference to process payment transactions. In embodiments where no institution priority preference is associated with the customer identifier, or if more than one issuer institutions in question are set with a same ranking, the payment network server 108 is configured to set a priority automatically based on a payment card type (e.g. a titanium card may be ranked at a higher priority than a gold card) associated with the more than one issuer institutions. If all payment cards are of the same type, the payment network server 108 may be configured to pick an issuer institution at random for processing the payment transaction. In other embodiments, if it is determined that the customer identifier is associated with more than one issuer institutions and that no institution priority preference is associated with the customer identifier, the payment network server 108 may be configured to transmit, to the customer electronic device 102 or the merchant server 104, a selection request requiring the customer associated with the customer electronic device 102 or the third party to select one of the issuer institutions associated with the customer identifier for processing the payment transaction. In this case, a selection response indicating at least the issuer institution is received at the payment network server 108 in return. The selection response may also indicate the payment card associated with the customer identifier which is to be used to process the payment transaction.

The payment network server 108 may be configured to determine, using the payment network database 114, if the customer identifier is associated with more than one customer payment card accounts. The payment network server 108 may be configured to query the payment network database 114 to identify the customer payment card account associated with the customer identifier if it is determined that the customer identifier is not associated with more than one customer payment card accounts. If it is determined that the customer identifier is associated with more than one customer payment card accounts, the payment network server 108 may be configured to query the payment network database 114 for an account priority preference associated with the more than one customer payment card accounts, and to identify a preferred customer payment card account associated with the customer identifier for use in the payment transaction. The account priority preference may comprise ranking the customer payment card accounts in order of a preference for use in processing payment transactions. In embodiments where no account priority preference is associated with the customer identifier, or if more than one customer payment card accounts in question are set with a same ranking, the payment network server 108 is configured to set a priority automatically based on a payment card type (e.g. a titanium card may be ranked at a higher priority than a gold card) associated with the customer payment card accounts. If all payment cards associated with the customer identifier are of the same card type, the payment network server 108 may be configured to pick a customer payment card account associated with the customer identifier at random. In other embodiments, where the customer identifier is associated with more than one customer payment card accounts and that no account priority preference is associated with the customer identifier, the payment network server 108 is configured to transmit, to the customer electronic device 102 or the merchant server 104, an account selection request requiring the customer associated with the customer electronic device 102 or the third party to select one of the customer payment card accounts associated with the customer identifier for processing the payment transaction. In this case, an account selection response indicating the issuer institution is received at the payment network server 108 in return.

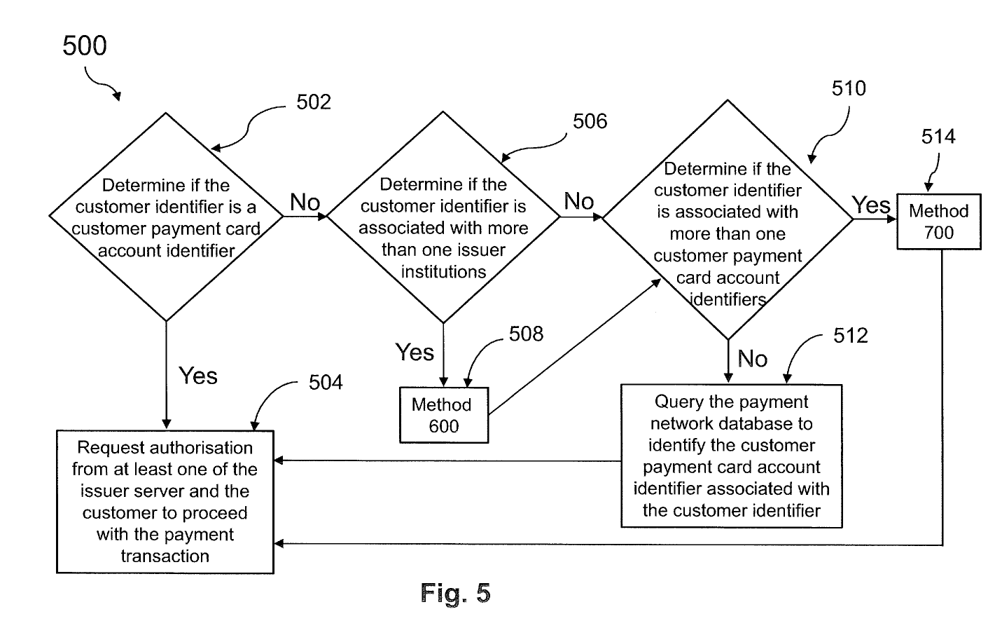

Details of the above described steps are discussed further in FIGS. 5 to 7. In an embodiment where the customer identifier is associated with one issuer institution and one customer payment card account, the payment network server 108 is configured to query the payment network database 114 associating issuer institutions with a plurality of customer identifiers to identify using the customer identifier an issuer institution and an associated issuer server prior to requesting authorisation to proceed with the payment transaction.

The payment network server 108 is configured to request authorisation to proceed with the payment transaction and to transmit a payment transaction response indicating an approval or a refusal for the payment transaction to proceed to the merchant server 104. The payment network server 108 may be configured to provide dummy values in fields typically comprised in transaction details, such as a card verification code (CVC2) and a card expiry date, if the information associated with the fields are not provided for the payment transaction and the dummy values have not been provided previously by the merchant server 104. The payment network server 108 may be configured to transmit an authentication request to the customer electronic device 102 seeking an approval by the customer to authenticate the payment transaction. The authentication request comprises a request for at least one customer authentication identifier, the at least one customer authentication identifier being associated with the customer identifier. The customer authentication identifier may be selected from one of the following: a personal identification number (PIN), a signature, a one-time password (OTP), a gesture, a name of a childhood friend, a wedding anniversary date, a specific voice command or a biometric identifier. After receiving the authentication request, the customer (i.e. the payment card holder or the payment account holder associated with the customer identifier) is prompted, via the customer electronic device 102, to respond to the authentication request. In embodiments, regardless of whether the customer or the third party initiates the payment transaction, the customer (i.e. the payment card holder or the payment account holder) is required to authenticate the payment transaction. The authentication response from the customer may then be sent from the customer electronic device 102 and received at the payment network server 108 as an authentication response, where the authentication response indicates if the payment transaction is authenticated from the customer electronic device 102. The authentication response may comprise at least one customer authentication identifier input (e.g. a confirmation code) in response to the at least one customer authentication identifier requested in the authentication request. The authentication request and the authentication response can be communicated to and from the customer electronic device 102 as provided by the communication architecture as shown in FIG. 1. For example, the payment network server 108 can communicate the authentication request to the customer electronic device 102 directly, while receiving the authentication response from the customer electronic device 102 via the merchant server 104 and the acquirer server 106. In another example, the authentication response is received by the payment network server 108 directly from the customer electronic device 102.

After receiving the authentication response from the customer, the payment network server 108 compares if the at least one customer authentication identifier input matches the at least one customer authentication identifier. The payment transaction may proceed if it is determined that the at least one customer authentication identifier input (e.g. a confirmation code) matches the at least on customer authentication identifier. If it is determined that the at least one customer authentication identifier input does not match the at least one customer authentication identifier, the payment transaction is refused. In this case, the customer or the third party who initiated the payment transaction may be prompted to provide another mode of payment for the payment transaction.

In some embodiments, the payment network server 108 may be configured to transmit an authorisation request to the issuer server 110 seeking an approval to proceed with the payment transaction, and to receive an authorisation response indicating if the payment transaction is approved or refused to proceed. In some embodiments, the payment network server 108 may also transmit the transaction request location received from the acquirer server 106 to the issuer server 110 as part of the authorisation request. The issuer server 110 is configured to receive the authorisation request from the payment network server 108.

In an authorisation process, the issuer server 110 may identify a customer payment card account associated with the customer identifier to check if the customer payment card account has sufficient balance or available credit for the payment transaction. In embodiments, where authentication processes which involve communicating with the customer to authenticate the payment transaction has not been carried out by the payment network server 108 as described above, the issuer server 110 may carry out the authentication processes in tandem with the authorisation process. In an embodiment, where the authentication processes have been carried out by the payment network server 108, the payment network server 108 transmits an authentication indicator to the issuer server 110 to indicate that the payment transaction request has been/will be authenticated. The issuer server 110 may be prompted to carry out the authentication process by an absence of the authentication indicator and a presence of the transaction indicator comprised in the authorisation request. In this case, the issuer server 110 may determine if the at least one customer authentication identifier input (e.g. a confirmation code received from the customer electronic device 102) matches the at least one customer authentication identifier. The payment transaction may proceed if it is determined that the at least one customer authentication identifier input matches the at least on customer authentication identifier.

In some embodiments where the transaction request location is comprised in the authorisation request received at the issuer server 110, the issuer server 110 is configured to locate the customer electronic device 102 via a sim tower and/or global positioning system (GPS). Other methods of locating the customer electronic device 102 may also be possible as long as they are deemed effective and efficient by the skilled person in the art. Moreover, the issuer server 110 may be configured to determine if a device location of the customer electronic device 102 is more than a distance threshold from the transaction request location before carrying out the authentication process as described above. The device location may be provided by the customer electronic device 102 to the issuer server 110 as a periodic update or it may be retrieved by the issuer server 110 when the device location is to be determined. The issuer server 110 may carry out the authentication process if the issuer server 110 determines that the device location of the customer electronic device 102 is more than a distance threshold from the transaction request location. Otherwise, the issuer server 110 may proceed to authorise without carrying out the authentication process. Alternatively in some embodiments, the issuer server 110 carries out the authentication process in parallel with determining if the device location of the customer electronic device 102 is more than a distance threshold from the transaction request location. In this case, if it is determined by the issuer server 110 that the device location of the customer electronic device 102 is more than a distance threshold from the transaction request location, the issuer server 110 may transmit a second authentication request to the customer electronic device 102 requesting a further authentication from the customer to approve the payment transaction request. This advantageously provides an added security measure, taking into account the geo-location of the customer electronic device 102 for authorising the payment transaction request. In particular, the use of the geo-location of the customer electronic device 102 coupled with the determination of the transaction request location enable the customer to trace any possible fraud location. For example, the issuer server 110 may be configured to extract the transaction request location to identify where the fraud transaction may have taken place. The issuer server 110 may advantageously provide such information to the customer when the customer files a complaint of the potential fraud transaction.

Based on results from the comparison of the transaction request location and the geo-location of the customer electronic device 102, and the authentication and the authorisation processes described above, the payment transaction can be approved or refused, and a payment transaction response indicating an approval or a refusal for the payment transaction to proceed can be transmitted to the merchant server 104. In an embodiment, the payment transaction is to proceed only if the authentication process and the authorisation process indicates approvals for the payment transaction to proceed.

The payment network server 108 may be configured to determine, based on the processes described above, if the payment transaction can proceed. In some embodiments, where the authentication process and the authorisation processes are carried out at the issuer server 110, the issuer server 110 may be configured to determine if the payment transaction can proceed. A payment transaction response indicating if the payment transaction can proceed may be generated by either the payment network server 108 or the issuer server 110. For example, if the payment network server 108 is configured to determine if the payment transaction can proceed, the payment network server 108 is further configured to generate a payment transaction response indicating an approval or a refusal for the payment transaction to proceed. Similarly, if the issuer server 110 is configured to determine if the payment transaction can proceed, the issuer server 110 is further configured to generate a payment transaction response indicating an approval or a refusal for the payment transaction to proceed. Whether the payment transaction response is generated by the payment network server 108 or the issuer server 110, it is routed to the acquirer server 106. The acquirer server 106, in turn, transmits the payment transaction response to the merchant server 104. If the payment transaction response indicates that the payment transaction is approved, then the account of the merchant is credited by the amount of the payment transaction following subsequent clearing and settlement processes, and the customer payment card account is debited accordingly. In embodiments where it is determined that the payment transaction is not to proceed, the payment network server 108 or the issuer server 110 prompts the customer via the customer electronic device 102 to provide an alternative form of payment. If the customer identifier is determined to be associated with more than one customer payment card accounts, the payment network server 108 may automatically attempt to restart the authorisation processes described above using another customer payment card account (e.g. in the ranked order of preference).

It is noted that the at least one customer authentication identifier associated with the customer identifier may be stored either at the issuer database 112 or at the payment network database 114 or at both databases 112, 114. The issuer database 112 is configured to be in communication with the issuer server 110, and may also be configured to be in communication with the payment network server 108 via the issuer server 110 for the purposes of the authentication process as described above. Similarly, the payment network database 114 is configured to be in communication with the issuer server 110, and may also be configured to be in communication with the payment network server 108 via the issuer server 110 for the purposes of the authentication process as described above.

The authentication request and the authentication response can be communicated to and from the customer electronic device 102 as provided by the communication architecture as shown in FIG. 1. For example, the issuer server 110 can communicate the authentication request to the customer electronic device 102 directly, while receiving the authentication response from the customer electronic device 102 via the merchant server 104, the acquirer server 106 and the payment network server 108. Alternatively, the authentication response may be received by the issuer server 110 directly from the customer electronic device 102. It will be understood by the skilled person in the art that the authentication process may be carried out by the payment network server 108 and/or the issuer server 110 in a mix and match manner as would be necessary for the payment transaction to be carried out in an efficient manner as deemed fit by the skilled person in the art.

In addition, a customer wearable device 116 associated with the customer electronic device 102 may form part of the computerised network 100. The customer wearable device 116 may be configured to disable the customer electronic device 102 for carrying out a payment transaction if the customer wearable device 116 is more than a pre-determined distance away from the customer electronic device 102. This advantageously provides an added security measure for carrying out payment transaction as the payment transaction will not be authenticated in a scenario where the customer electronic device 102 is stolen. In an embodiment, where the customer electronic device 102 is communicatively connected to the customer wearable device 116, authentication of the payment transaction is communicated to the payment network server 108 or the issuer server 110 via the customer wearable device 116 and/or the customer electronic device 102. The pre-determined distance may be determined by the customer via the customer electronic device 102 or the customer wearable device 116.

To utilise the processes as described above, the customer may have to register with the payment network server 108 and/or the issuer server 110. The customer may register directly with the payment network or the issuer institution. In particular, information associated with a customer (e.g. details of a customer electronic device associated with the customer, a customer identifier, details of a customer payment card account identifier etc.) may be received from the customer and stored in the payment network database 114 when the customer is registered as a party to payment transactions processed using the transaction indicator. In embodiments, an institution priority preference and/or an account priority preference may be provided by the customer (i.e. payment card holder or account holder) when the customer registers for processing payment transactions using a transaction indicator. The customer may also provide details of the institution priority preference and/or an account priority preference at any time after the customer is registered. The customer may update his/her institution priority preference and/or account priority preference with a relevant issuer institution, and the updated institution priority preference and/or account priority preference may be transmitted to the payment network server 108 and stored at the payment network database 114. The process of updating these two preferences may be done periodically. In embodiments, the payment network server 108 checks with the relevant issuer institution periodically (e.g. every week, every 2 weeks, every month, every two months, or every three months etc.) to determine if there is any update to the institution priority preference and/or the account priority preference. Moreover, issuer institutions may also be registered to process payment transactions using the transaction indicator with the customer identifier. A request may be received from a customer electronic device 102 associated with a customer and/or an issuer server 110 associated with an issuer institution at the payment network server 108 to register the customer and/or the issuer institution respectively with the payment network database 114. In embodiments, the customer may choose to register for processing payment transactions using the transaction indicator for a selected number of customer payment cards and/or payment card accounts, and/or for transaction amounts within a specified range. The customer may choose the customer payment cards and/or payment card accounts via the App installed on the customer electronic device 102 or to register with the payment network or the issuer institution(s) using the internet.

As a further example, the above processes may also be used for an automated teller machine (ATM) transaction (i.e. where the merchant is constituted by an ATM). In this case, the customer or the third party may select from options provided by the automated teller machine to provide a customer identifier for processing a transaction at the automated teller machine. The customer identifier may be routed to the issuer server 110 where the customer identifier is used to identify a customer payment card account associated with the customer. The issuer server 110 may be configured to determine a geo-location of a customer electronic device 102 associated with the customer, and carry out authentication and authorisation processes as described above to facilitate the processing of the ATM transaction.

As will be understood by a skilled person, each of the various apparatuses in the computerised network 100 has a communication module such as a wireless interface for two-way communication between one and another via a communication network. The communication network could be any types of network, for example, virtual private network (VPN), the Internet, a local area and/or wide area network (LAN and/or WAN), and so on.

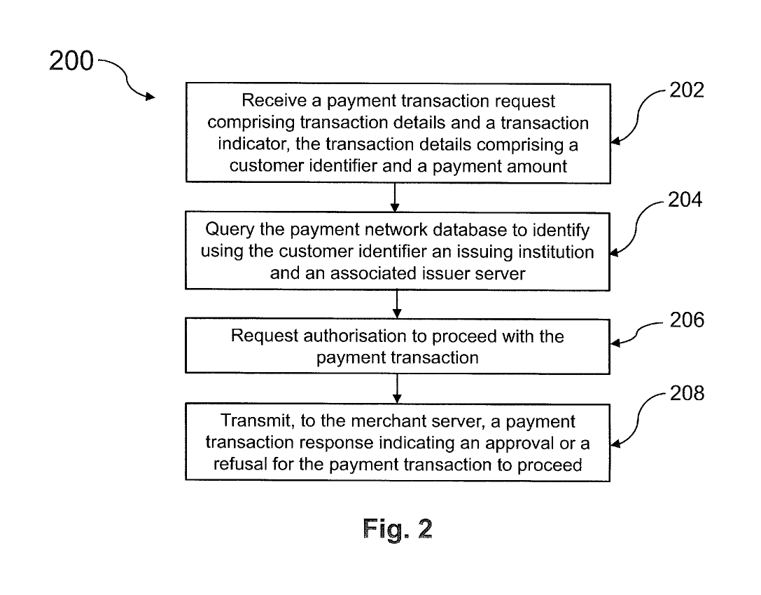

A method 200 carried out by the payment network server 108 of the computerised network 100 is illustrated in FIG. 2.

Referring to FIG. 2, in a step 202, the payment network server 108 receives a payment transaction request from the merchant server 104, where the payment transaction request comprises transaction details and a transaction indicator. The payment transaction request may be initiated by a customer or a third party associated with the customer (e.g. a friend or a relative of the customer). The transaction details comprises a customer identifier associated with the customer for the payment transaction and a payment amount, and the transaction indicator indicates that the payment transaction is to proceed using the customer identifier and the payment amount. The payment transaction request may be received from the merchant server 104 via the acquirer server 106. In an embodiment, only the customer identifier and the payment amount are required to process the payment transaction. Any information, such as a card verification code (CVC2) and a card expiry date, which is not comprised in the transaction details may be substituted using dummy values by the payment network server 108 or the merchant server 104.

In a step 204, the payment network server 108 queries a payment network database 114 associating issuer institutions with a plurality of customer identifiers to identify using the customer identifier an issuer institution and an associated issuer server 110. This may be carried out straightforwardly in a scenario where the customer identifier is associated with one issuer institution and one customer payment card account. In some embodiments, further processing steps may be carried out by the payment network server 108 prior to or at this step 204. These processing steps are discussed in more detail below in relation to FIGS. 5 to 7.

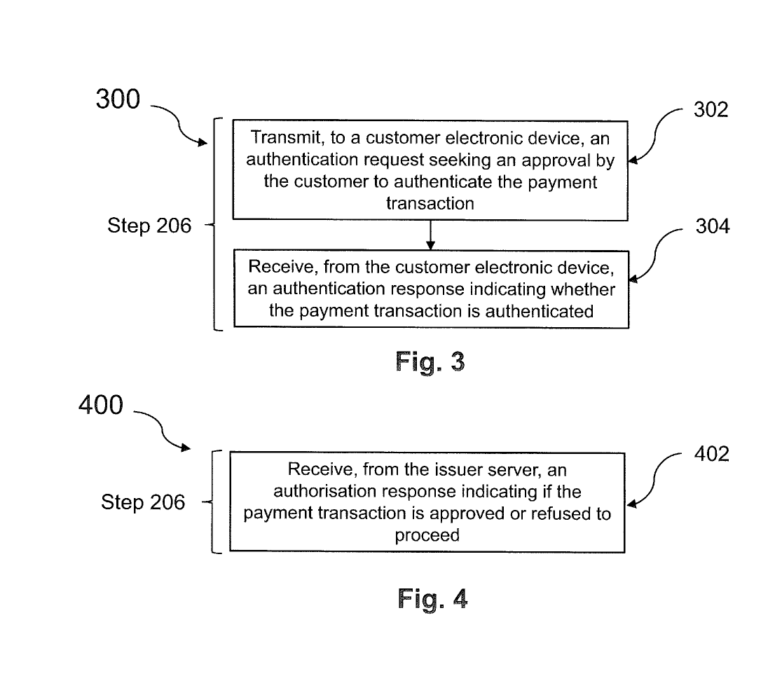

In a step 206, the payment network server 108 requests authorisation to proceed with the payment transaction. The authorisation to proceed with the payment transaction may comprise an authentication process by the customer via the customer electronic device 102 and an authorisation process by the issuer server 110. The authentication process may be initiated by the payment network server 108 or the issuer server 110, while the authorisation process is initiated by the payment network server 108 and carried out at the issuer server 110. In an embodiment, the authentication process comprises either the payment network server 108 or the issuer server 110 transmitting an authentication request to the customer electronic device 102 seeking an approval by the customer to authenticate the payment transaction. An example of the authentication process initiated by the payment network server 108 is described in FIG. 3. In the authorisation process, the payment network server 108 is configured to transmit an authorisation request to the issuer server 110 seeking an approval to proceed with the payment transaction, and to receive an authorisation response indicating if the payment transaction is approved or refused to proceed. An example of the authorisation process is shown in FIG. 4.

In a step 208, the payment network server 108 transmits, to the merchant server 104, a payment transaction response indicating an approval or a refusal for the payment transaction to proceed. The payment transaction response may be generated by the payment network server 108 or the issuer server 110.

FIG. 3 shows additional steps of a method 300 which may be performed by the payment network server 108 of FIG. 1 in accordance with an embodiment of the invention. The method 300 may be carried out by the payment network server 108 as further steps within the step 206 of method 200 in FIG. 2.

Referring to FIG. 3, in a step 302 of the method 300, the payment network server 108 transmits, to the customer electronic device 102, an authentication request seeking an approval by the customer to authenticate the payment transaction. In an embodiment, the customer electronic device 102 is identified using the customer identifier comprised in the payment transaction request. The authentication request comprises a request for at least one customer authentication identifier, the at least one customer authentication identifier being associated with the customer identifier. The customer authentication identifier may be selected from one of the following: a personal identification number (PIN), a signature, a one-time password (OTP), a gesture, a name of a childhood friend, a wedding anniversary date, a specific voice command or a biometric identifier. After receiving the authentication request, the customer is prompted, via the customer electronic device 102, to respond to the authentication request. The authentication response from the customer may then be sent from the customer electronic device 102 and received at the payment network server 108 or the issuer server 110 as an authentication response, the authentication response indicating if the payment transaction is authenticated from the customer electronic device 102. In an embodiment, the authentication response comprises at least one customer authentication identifier input (e.g. a confirmation code received from the customer electronic device 102) in response to the at least one customer authentication identifier requested in the authentication request. The authentication request and the authentication response can be communicated to and from the customer electronic device 102 as provided by the communication architecture as shown in FIG. 1.

In a step 304, the payment network server 108 receives, from the customer electronic device, an authentication response indicating if the payment transaction is authenticated. After receiving the authentication response from the customer, the payment network server 108 may be further configured to compare if the at least one customer authentication identifier input matches the at least one customer authentication identifier. The payment transaction can proceed if it is determined that the at least one customer authentication identifier input matches the at least on customer authentication identifier. Otherwise, the payment transaction is refused. In this case, the customer may be prompted to provide another mode of payment for the payment transaction.

FIG. 4 shows additional steps which may be performed by the payment network server 108 of FIG. 1 in accordance with an embodiment of the invention. The method 400 may be carried out by the payment network server as further steps within the step 206 of method 200 in FIG. 2.

In a step 402, the payment network server 108 receives, from the issuer server 110, an authorisation response indicating if the payment transaction is approved or refused to proceed. In order to authorise the payment transaction, the issuer server 110 may identify a customer payment card account associated with the customer identifier to check if the customer payment card account has sufficient balance or available credit for the payment transaction. In an embodiment, the authentication process described in FIG. 3 may be initiated by the issuer server 110. In this case, the authorisation response received by the payment network server 108 may indicate an approval for the payment transaction to proceed if the payment transaction is authenticated by the customer via the customer electronic device 102. Moreover, the issuer server 110 may also determine if a device location of the customer electronic device 102 is within a pre-determined distance from a transaction request location. An approval for the payment transaction to proceed may be indicated if the customer electronic device 102 is within the pre-determined distance from the transaction request location. Therefore, the authorisation response may indicate an approval for the payment transaction to proceed if there is sufficient balance for the payment transaction and/or if the customer electronic device 102 is within the pre-determined distance from the transaction request location and/or if customer has authenticated the payment transaction.

It is noted that the method 300 in FIG. 3 and the method 400 in FIG. 4 may be carried out in parallel and the results of which may be used in combination to determine if the payment transaction is to proceed.

FIG. 5 shows additional steps which may be performed by the payment network server 108 of FIG. 1 in accordance with an embodiment of the invention.

In a step 502, the payment network server 108 determines if the customer identifier is a customer payment card account identifier.

If it is determined by the payment network server 108 that the customer identifier is a customer payment card account identifier, the payment network server 108 is configured to request authorisation from a least one of the issuer server and the customer to proceed with the payment transaction in a step 504, where the authorisation request comprises at least the transaction indicator, the customer payment card account identifier and the payment amount. The issuer server 110 may be prompted to carry out the authentication process by the transaction indicator comprised in the authorisation request. In an embodiment, where the authentication processes have been carried out by the payment network server 108, the payment network server 108 transmits an authentication indicator to the issuer server 110 to indicate that the payment transaction request has already been authenticated.

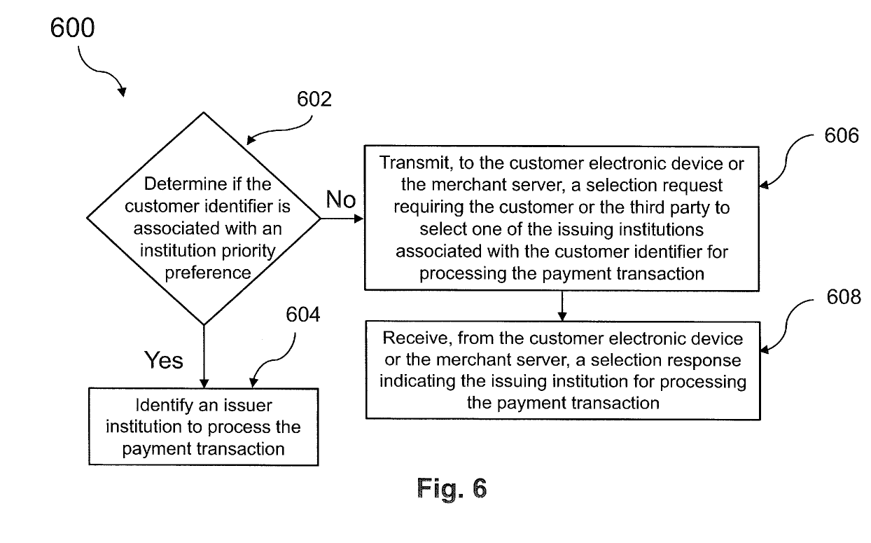

If it is determined by the payment network server 108 that the customer identifier is a personal identifier other than a customer payment card account identifier, the payment network server 108 is configured to determine, using the payment network database 114, whether the customer identifier is associated with more than one issuer institutions in a step 506. If the customer identifier is associated with more than one issuer institutions, the payment network server 108 may be configured to carry out a method 600 in a step 508 which will be discussed later in FIG. 6. Regardless of whether the customer identifier is associated with more than one issuer institutions, the payment network server 108 is configured to determine, using the payment network database 114, whether the customer identifier is associated with more than one customer payment card accounts in a step 510. If the customer identifier is determined to be associated with more than one issuer institutions, the method 600 will be carried out prior to proceeding with the step 510 as shown in FIG. 5.

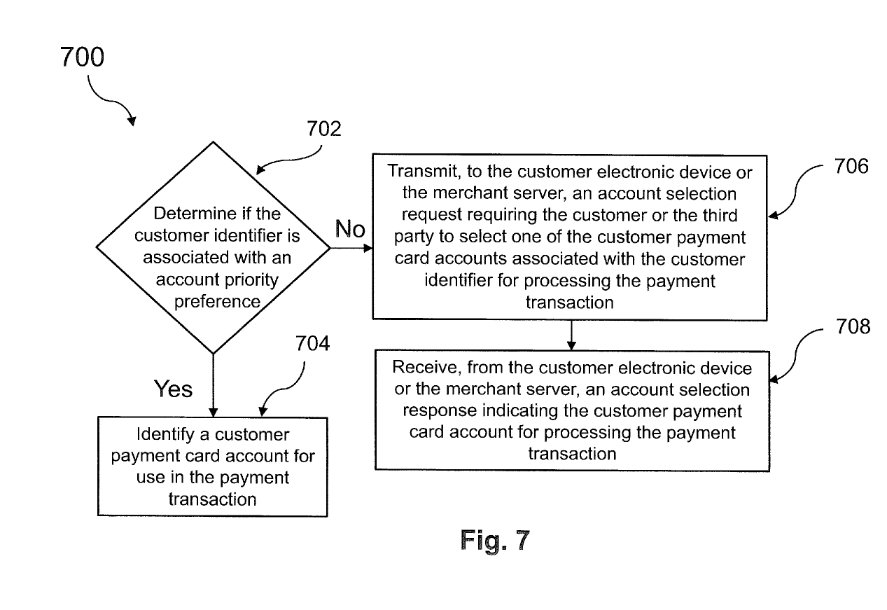

In a step 512, where the customer identifier is not associated with more than one customer payment card accounts, the payment network server 108 may be configured to query the payment network database 114 to identify the customer payment card account associated with the customer identifier prior to requesting authorisation to proceed with the payment transaction in the step 504. In embodiments where the customer identifier is associated with more than one customer payment card accounts, the payment network server 108 is configured to carry out a method 700 in a step 514 which will be discussed later in FIG. 7. In this case, after the method 700 is completed, the payment network server 108 may request authorisation to proceed with the payment transaction in the step 504.

As is illustrated in FIG. 5, in embodiments where the customer identifier is associated with one issuer institution and one customer payment card account, the payment network server 108 is configured to query the payment network database 114 associating issuer institutions with a plurality of customer identifiers to identify using the customer identifier an issuer institution and an associated issuer server prior to requesting authorisation to proceed with the payment transaction.

FIG. 6 shows additional steps to the method of FIG. 5 which may be performed by the server in accordance with an embodiment of the invention.

In a step 602, the payment network server 108 is configured to query the payment network database 114, to determine if the customer identifier is associated with an institution priority preference, the institution priority preference comprises a list of the more than one issuer institutions ranked in order of preference for processing the payment transaction.

If it is determined that the customer identifier is associated with the institution priority preference, the payment network server 108 is configured to identify an issuer institution to process the payment transaction. The issuer institution to process the payment transaction is the one which is ranked to have the highest priority/preference by the customer for processing payment transactions using a transaction indicator.

If it is determined in the step 602 that the customer identifier is not associated with an institution priority preference, the payment network server 108 is configured to transmit, to the customer electronic device 102 or the merchant server 104, a selection request requiring the customer associated with the customer electronic device 102 or the third party to select one of the issuer institutions associated with the customer identifier for processing the payment transaction in a step 606.

In a step 608, the payment network server 108 is configured to receive, from the customer electronic device 102 or the merchant server 104, a selection response indicating the issuer institution is received at the payment network server 108 in return. Upon receiving the selection response, the payment network server 108 may be configured to perform step 510 and onwards as illustrated in the method 500 to proceed with processing the payment transaction.

In other embodiments (not shown in FIG. 6), if it is determined in the step 602 that the customer identifier is not associated with the institution priority preference, or if more than one issuer institutions in question are set with a same ranking, the payment network server 108 may be configured to set a priority automatically based on a payment card type (e.g. a titanium card may be ranked at a higher priority than a gold card) associated with the more than one issuer institutions. If all payment cards associated with the customer identifier are of the same type, the payment network server 108 may be configured to pick an issuer institution at random for processing the payment transaction.

FIG. 7 shows additional steps to the method of FIG. 5 which may be performed by the server in accordance with an embodiment of the invention.

In a step 702, the payment network server 108 is configured to query the payment network database 114, to determine if the customer identifier is associated with an account priority preference, the account priority preference comprises a list of customer payment card accounts ranked in order of preference for use in the payment transaction.

If it is determined that the customer identifier is associated with the account priority preference, the payment network server 108 is configured to identify a customer payment account for use in the payment transaction. The customer payment account for use in the payment transaction is the one which is ranked to have the highest priority/preference by the customer for use in payment transactions using a transaction indicator.

If it is determined in the step 702 that the customer identifier is not associated with an account priority preference, the payment network server 108 is configured to transmit, to the customer electronic device 102 or the merchant server 104, an account selection request requiring the customer associated with the customer electronic device 102 or the third party to select one of the customer payment card accounts associated with the customer identifier for processing the payment transaction in a step 706.

In a step 708, the payment network server 108 is configured to receive, from the customer electronic device 102 or the merchant server 104, an account selection response indicating the customer payment card account which is received at the payment network server 108 in return. Upon receiving the account selection response, the payment network server 108 may be configured to request authorisation from at least one of the issuer sever and the customer to proceed with the payment transaction in the step 504.

In other embodiments (not shown in FIG. 7), if it is determined in the step 702 that the customer identifier is not associated with an account priority preference, or if more than one of the customer payment card accounts in question are set with a same ranking, the payment network server 108 may be configured to set a priority automatically based on a payment card type (e.g. a titanium card may be ranked at a higher priority than a gold card) associated with the one or more customer payment card accounts. If all payment cards associated with the customer identifier are of the same card type, the payment network server 108 may be configured to pick a customer payment card account associated with the customer identifier at random for processing the payment transaction.

In embodiments, the institution priority preference and the account priority preference comprise separate ranking lists associated with an order of preference for using the issuer institutions or the customer payment card accounts for processing payment transactions using a transaction indicator respectively. In other embodiments, the institution priority preference and/or the account priority preference may be of a same combined ranking list. In any case, the institution priority preference and/or the account priority preference may be provided by a customer (e.g. payment card holder or account holder) associated with the customer identifier when the customer registers for processing payment transactions using a transaction indicator. The institution priority preference and/or the account priority preference may be provided by the customer at any time after the customer is registered. The customer may update his/her institution priority preference and/or account priority preference with a relevant issuer institution and the updated institution priority preference and/or account priority preference may be transmitted to the payment network server 108 and be stored at the payment network database 114. The process of updating these two preferences may be done periodically. In embodiments, the payment network server 108 checks with the relevant issuer institution periodically (e.g. every week, every 2 weeks, every month, every two months, or every three months etc.) to determine if there is any update on the institution priority preference and/or the account priority preference associated with the customer.

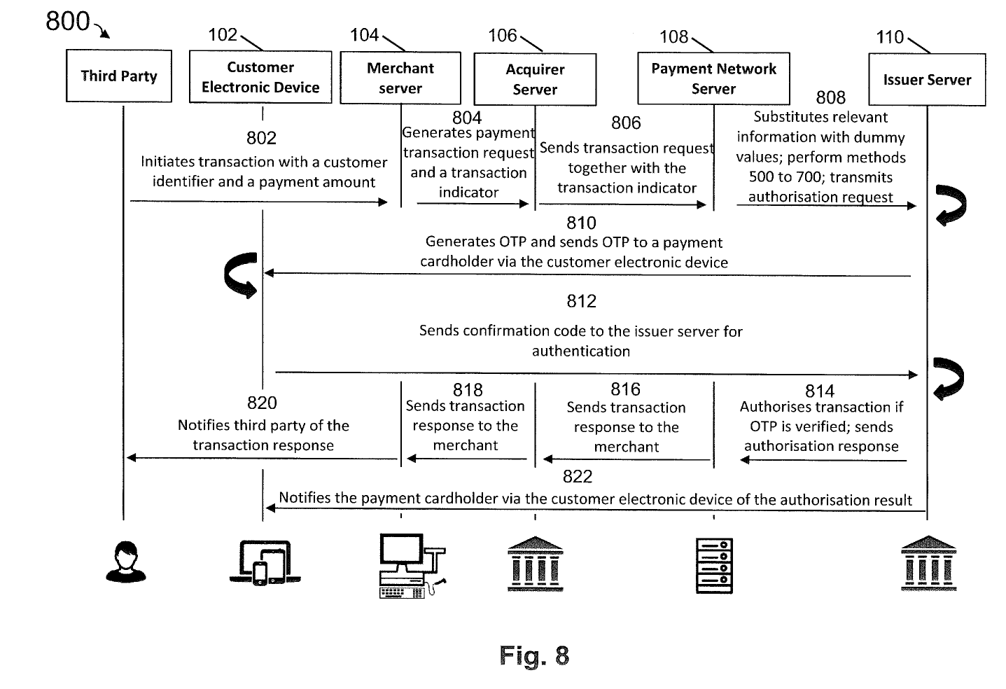

FIG. 8 illustrates an exemplary embodiment for processing a payment transaction initiated by a third party (e.g. a friend or a relative associated with a customer (i.e. a payment card holder or account holder) other than the customer, for example, when the customer is not present. The third party may initiate a payment transaction at a merchant apparatus associated with a merchant server 104 in a retail location associated with a merchant. The merchant apparatus may be an ATM or a Point-of-Sale (POS) terminal. A payment transaction may also be initiated online via a merchant internet website associated with the merchant server 104.

The third party initiates a payment transaction for a payment transaction by providing at least a customer identifier at the merchant server 104 in a step 802. The customer identifier is associated with a payment card or a payment account related to a customer (e.g. a friend or a relative of the third party). The transaction request comprises at least transaction details where the transaction details comprise the customer identifier and a payment amount where the payment amount is related to products to be purchased by the third party. In an embodiment, the merchant server 104 may be configured to identify a payment transaction that uses a customer identifier. The merchant server 104 may also be configured to prompt the third party to provide information of a payment network (e.g. MasterCard® or VISA®) which is to be used for the payment transaction. In another embodiment, the third party is required to specify at the merchant server 104 when initiating the payment transaction that it is a payment card transaction using a customer identifier. This may be done by selecting an option which may be presented to the third party at the time of initiating the payment transaction. In either of the above cases, the merchant server 104 introduces a transaction indicator to be tagged to the transaction request once it is identified that the payment transaction request is associated with a customer identifier, where the transaction indicator indicates that the payment transaction is to proceed using the customer identifier and the payment amount (i.e. not requiring all the normal payment card data fields to be filled). The merchant server 104 then transmits a payment transaction request comprising the transaction details and the transaction indictor to the acquirer server 106 in a step 804, which the acquirer server 106 forwards the information to the payment network server 108 to be processed in a step 806.

After the payment transaction request is received from the acquirer server 106 at the step 806, the payment network server 108 is configured to carry out the processes as detailed in FIGS. 5 to 7 (i.e. methods 500 to 700) before requesting authorisation for the payment transaction. In embodiments, the transaction indicator comprised in the payment transaction request prompts the payment network server 108 to carry out these processes. The payment network server 108 may be configured to provide dummy values in fields typically comprised in transaction details, such as a card verification code (CVC2) and a card expiry date, if the information associated with the fields are not provided for the payment transaction and the dummy values have not been provided previously by the merchant server 104.

In the present embodiment, once the necessary processing steps have been completed at the payment network server 108 and a relevant issuer server 110 has been identified, the payment network server 108 transmits an authorisation request to the issuer server 110 at the step 808. The authorisation request comprises the payment transaction request (i.e. the transaction details and the transaction indicator comprised in the payment transaction request) as well as the customer payment card account associated with the customer identifier identified at the payment network server 108. In an embodiment, the customer payment card account associated with the customer identifier may not be identified at the payment network server 108. In this case, the identification of the payment card account associated with the customer identifier may be carried out at the issuer server 110.

The issuer server 110 is configured to generate a one-time password (OTP) to the cardholder once it receives the authorisation request for the payment transaction using the customer identifier from the payment network server 108 at the step 808. The customer identifier accompanying the authorisation request may serve to indicate to the issuer server 110 that an authentication from the customer (e.g. the cardholder) is required to proceed with the payment transaction. The customer identifier may also serve to indicate that the payment transaction is to proceed or authorised using the customer identifier and the payment amount. The OTP is sent to the customer associated with the customer identifier via the customer electronic device 102 in a step 810. The OTP may be in the form of a barcode, a Quick Response (QR) code, a string of numbers or alphanumeric. The OTP may be displayed on the customer electronic device 102 so that the cardholder may be informed of the OTP. The customer electronic device 102 may be a mobile phone, a personal computer, a tablet, a laptop, a key-fob or a personal digital assistant (PDA). The OTP can then be provided as an authentication for the payment transaction. The customer is also notified in the step 810 if he/she would like to complete the payment transaction initiated by the third party with the OTP. In an embodiment, if the customer wishes to complete the payment transaction, the customer inputs the OTP into the customer electronic device 102 as a confirmation code which is subsequently sent to the issuer server 110 in a step 812. The confirmation code entered by the customer serves to authenticate the payment transaction. The customer may enter the confirmation code through a mobile banking application on the customer electronic device 102 or through an online banking account of the customer.

The issuer server 110 is configured to determine if the confirmation code received in the step 812 matches the OTP sent by the issuer server 110 in the step 810. The payment card transaction is authenticated if it is determined that the confirmation code received from the customer matches the OTP sent to the customer. In the case that the confirmation code received matches the OTP sent to the customer, the payment transaction is authenticated. The issuer server 110 may also consider other conditions (e.g. if the customer payment card account has sufficient balance or available credit for the payment transaction) before authorising the payment transaction. Once the payment transaction is authenticated and the necessary conditions fulfilled, an authorisation response to approve the payment transaction is transmitted from the issuer server 110 to the payment network server 108 in a step 814. Otherwise, in the event that the confirmation code does not match the OTP, the issuer server 110 transmits an authorisation response comprising a refusal to proceed with the payment transaction to the payment network server 108 and the payment card transaction initiated by the third party is refused.

The payment network server 108 in turn transmits a payment transaction response indicating whether the payment transaction has been authorised to the acquirer server 106 in a step 816. The payment transaction response is then forwarded to the merchant server 104 by the acquirer server 106 in a step 818. Once the payment transaction response is received at the merchant server 104, the third party who initiated the payment transaction is notified of a result of the transaction by the merchant server 104 in a step 820. The customer (e.g. payment cardholder) may also be informed of a result of the transaction or authorisation by the issuer server 110 in a step 822. The payment card transaction is either completed, or the payment card transaction is refused.

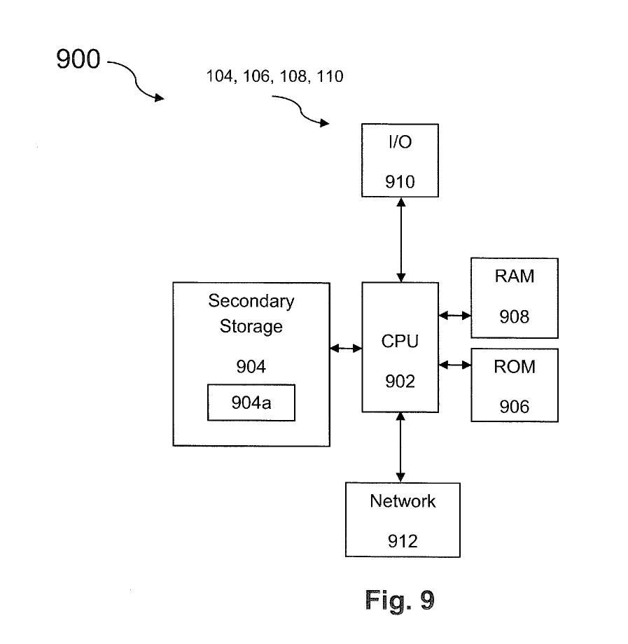

FIG. 9 is a block diagram showing a technical architecture 900 of the merchant server 104, the acquirer server 106, the payment network server 108 and/or the issuer server 110.

The technical architecture 900 includes a processor 902 (which may be referred to as a central processor unit or CPU) that is in communication with memory devices including secondary storage 904 (such as disk drives), read only memory (ROM) 906, and random access memory (RAM) 908. The processor 902 may be implemented as one or more CPU chips. The technical architecture may further comprise input/output (I/O) devices 910, and network connectivity devices 912.

The secondary storage 904 is typically comprised of one or more disk drives or tape drives and is used for non-volatile storage of data and as an over-flow data storage device if RAM 908 is not large enough to hold all working data. Secondary storage 904 may be used to store programs which are loaded into RAM 908 when such programs are selected for execution.

In this embodiment, the secondary storage 904 has a processing component 904a comprising non-transitory instructions operative by the processor 902 to perform various operations of the method of the present disclosure. The ROM 906 is used to store instructions and perhaps data which are read during program execution. The secondary storage 904, the RAM 908, and/or the ROM 906 may be referred to in some contexts as computer readable storage media and/or non-transitory computer readable media.

I/O devices 910 may include printers, video monitors, liquid crystal displays (LCDs), plasma displays, touch screen displays, keyboards, keypads, switches, dials, mice, track balls, voice recognizers, card readers, paper tape readers, or other input devices.

The network connectivity devices 912 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 912 may enable the processor 902 to communicate with the Internet or one or more intranets. With such a network connection, it is contemplated that the processor 902 might receive information from the network, or might output information to the network in the course of performing the above-described method operations. Such information, which is often represented as a sequence of instructions to be executed using processor 902, may be received from and outputted to the network, for example, in the form of a computer data signal embodied in a carrier wave.

The processor 902 executes instructions, codes, computer programs, scripts which it accesses from hard disk, floppy disk, optical disk (these various disk based systems may all be considered secondary storage 904), flash drive, ROM 906, RAM 908, or the network connectivity devices 912. While only one processor 902 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 900 to provide the functionality of a number of servers that is not directly bound to the number of computers in the technical architecture 900. In an embodiment, the functionality disclosed above may be provided by executing an application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 902, the RAM 908, and the ROM 906 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

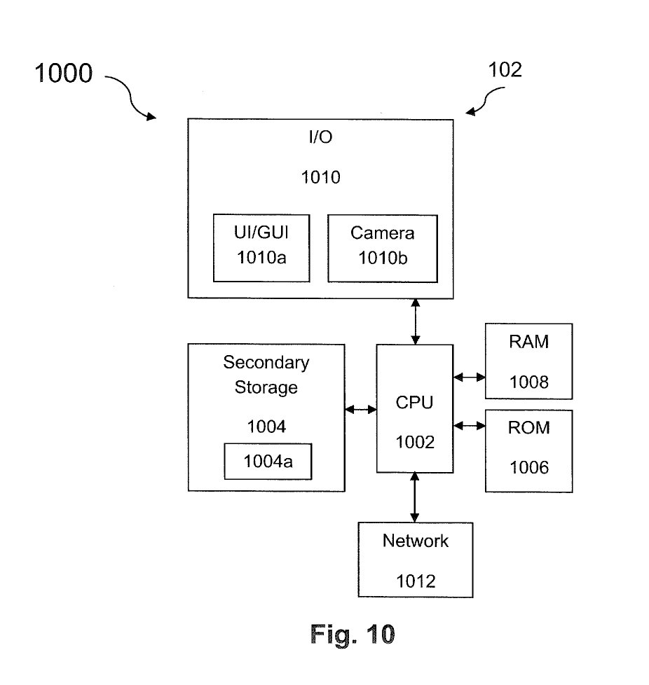

FIG. 10 is a block diagram showing a technical architecture 1000 of a communication device (e.g. the customer electronic device 102 and/or the customer wearable device 116 of the customer). The technical architecture includes a processor 1002 (which may be referred to as a central processor unit or CPU) that is in communication with memory devices including secondary storage 1004 (such as disk drives or memory cards), read only memory (ROM) 1006, and random access memory (RAM) 1008. The processor 1002 may be implemented as one or more CPU chips. The technical architecture further comprises input/output (I/O) devices 710, and network connectivity devices 1012.

The I/O devices 1010 comprise a customer interface (UI) 1010a and a camera 1010b. The UI 1010a may comprise a screen in the form of a touch screen, a keyboard, a keypad or other known input device. The camera 1010b is a device for recording visual images in the form of photographs, film or video signals. The UI 1010a may be configured to operate with the processor 1002 together with the memory devices 1004, 1006, 1008 in conjunction with the network connectivity devices 1012 to display to the customer an authentication request requesting for a customer authentication identifier to be input via the I/O devices 1010. The customer authentication identifier may be input via the UI 1010a or the camera 1010b (e.g. if the customer authentication identifier is associated with a biometric identifier).

The secondary storage 1004 is typically comprised of a memory card or other storage device and is used for non-volatile storage of data and as an over-flow data storage device if RAM 1008 is not large enough to hold all working data. Secondary storage 1004 may be used to store programs which are loaded into RAM 1008 when such programs are selected for execution.

In this embodiment, the secondary storage 1004 has a processing component 1004a, comprising non-transitory instructions operative by the processor 1002 to perform various operations of the method of the present disclosure. The ROM 1006 is used to store instructions and perhaps data which are read during program execution. The secondary storage 1004, the RAM 1008, and/or the ROM 1006 may be referred to in some contexts as computer readable storage media and/or non-transitory computer readable media.

The network connectivity devices 1012 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 1012 may enable the processor 1002 to communicate with the Internet or one or more intranets. With such a network connection, it is contemplated that the processor 1002 might receive information from the network, or might output information to the network in the course of performing the above-described method operations. Such information, which is often represented as a sequence of instructions to be executed using processor 1002, may be received from and outputted to the network, for example, in the form of a computer data signal embodied in a carrier wave. In embodiments, the network connectivity devices 1012 enable the customer electronic device 102 and the customer wearable device 116 to be communicatively connected to each other. The network connectivity devices 1012 may also enable the customer electronic device 102 to be in communication with the merchant server 104 and/or the payment network server 108 and/or the issuer server 110.

The processor 1002 executes instructions, codes, computer programs, scripts which it accesses from hard disk, floppy disk, optical disk (these various disk based systems may all be considered secondary storage 1004), flash drive, ROM 1006, RAM 1008, or the network connectivity devices 1012. While only one processor 1002 is shown, multiple processors may be present. Thus, while instructions may be discussed as executed by a processor, the instructions may be executed simultaneously, serially, or otherwise executed by one or multiple processors. In an embodiment, if an App compatible with the authentication process is used, the processor 1002 is configured to execute the App stored in the ROM 1006 and/or RAM 1008 or the secondary storage 1004 for authentication of a payment transaction as described in the exemplary embodiments.

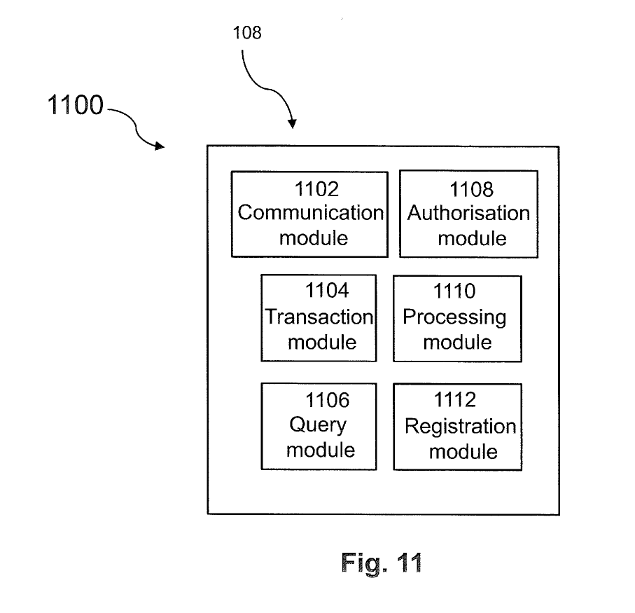

FIG. 11 shows schematically the structure 1100 of the payment network server 108 comprised in the computerised network 100 of FIG. 1 to carry out the methods of FIGS. 2 to 7 in accordance with an embodiment of the invention. The structure 1100 of the payment network server 108 comprises a communication module 1102, a transaction module 1104, a query module 1106, an authorisation module 1108, a processing module 1110 and a registration module 1112.

The communication module 1102 is configured to enable the payment network server 108 to communicate with at least an acquirer server 106 and an issuer server 110 as provided in the computerised network 100 of FIG. 1. In an embodiment, the communication module 1102 is further configured to enable the payment network server 108 to communicate with a merchant computer apparatus 104 and/or a customer electronic device 102 directly.

The transaction module 1104 is configured to allow the payment network server 108 to process a payment transaction request. In particular, the transaction module 1104 identifies and sorts information included in the transaction details for use in further processes (e.g. querying of a payment network database 114 in the step 204 and requesting authorisation in the step 206 etc.). In particular, the transaction module 1104 is also configured to identify if the payment transaction request comprises a transaction indicator, where the transaction indicator indicates that the payment transaction can proceed using only the customer identifier and the payment amount. The transaction module 1104 may be further configured to substitute information which is not comprised in the transaction details (i.e. information or fields within the transaction details which are not available and/or not given for the payment transaction request) using dummy values. Relevant information or fields which are generally required in a payment transaction include a card verification code (CVC2), a card expiry date, a billing address of the customer, a payment card number, a personal identification number (PIN) etc. Dummy values can be any alphanumerical value or symbols or the like which serve to occupy the fields within the transaction details. Moreover, the transaction module 1104 may transmit the relevant information isolated from the transaction request to other modules of the payment network server 108 for further processing.

The query module 1106 is configured to communicate, via the communication module 1102, with the payment network database 114 associating issuer institutions with a plurality of customer identifiers to identify using the customer identifier an issuer institution and an associated issuer server. In other words, the query module 1106 may be configured to carry out the step 204 as shown in FIG. 2. In addition, the query module 1106 may be further configured to identify customer payment card account identifier(s) associated with the customer identifier, the customer payment card account identifier(s) being associated with a customer payment card account maintained by the issuer institution. An example is shown in the step 512 of FIG. 5. The query module 1106 may be configured to query the payment network database 114 to determine if the customer identifier is associated with an institution priority preference (e.g. in the step 602) or if the customer identifier is associated with an account priority preference (e.g. in the step 702).

The authorisation module 1108 is configured to communicate, via the communication module 1102, with the issuer server 110 identified using the payment network database 114 as being associated with the customer identifier for the payment transaction. In particular, the authorisation module 1108 is configured to transmit an authorisation request to the issuer institution seeking an approval by the issuer institution to authorise the transaction request received at the transaction module 1104, and to receive an authorisation response from the issuer institution comprising the approval or an refusal by the issuer institution to proceed with the payment transaction. In an embodiment, the authorisation module 1108 is also configured to transmit an authentication request to a customer electronic device 102 seeking an approval by the customer to authenticate the payment transaction, and to receive an authentication response indicating if the payment transaction is authenticated. The authorisation module 808 may be configured to communicate, via the communication module 1102, with the payment network database 114 to identify the customer electronic device 102 using the customer identifier comprised in the payment transaction request received at the transaction module 1104. The authorisation module 1108 may also be configured to compare if the at least one customer authentication identifier input received from the customer electronic device 102 matches the at least one customer authentication identifier using the information stored at the payment network database 114. The payment transaction can proceed if it is determined that the at least one customer authentication identifier input matches the at least on customer authentication identifier. If it is determined that the at least one customer authentication identifier input does not match the at least one customer authentication identifier, the payment transaction is refused. In this case, the authorisation module 1108 may work in conjunction with the communication module 1102 to prompt the customer, via the merchant server 104, to provide another mode of payment for the payment transaction.

The processing module 1110 is configured to determine if the customer identifier is a customer payment card account identifier before transmitting the authorisation request to the issuer server 110, the customer payment card account identifier being associated with a customer payment card account maintained by the issuer institution. In an embodiment, where it is determined that the customer identifier is the customer payment card account identifier, the processing module 1110 is configured to work with the authorisation module 1108 to transmit, via the communication module 1102, an authorisation request comprising at least the customer payment card account identifier and the payment amount seeking an approval by the issuer institution to authorise the payment transaction request to the issuer server 110. In an embodiment, where it is determined by the processing module 1110 that the customer identifier is a personal identifier other than a customer payment card account identifier, the processing module 1110 is configured to work with the query module 1106 to determine, using the payment network database 114, whether the customer identifier is associated with more than one issuer institutions. If it is determined that the customer identifier is associated with more than one issuer institutions, the processing module 1110 may be configured to work with the query module 1106 to query the payment network database 114 for an institution priority preference for the issuer institutions, and to identify a preferred issuer institution associated with the customer identifier. The institution priority preference may comprise ranking the issuer institutions associated with the customer identifier in order of a preference to process payment transactions. In embodiments where no institution priority preference is associated with the customer identifier, or if more than one issuer institutions in question are set with a same ranking, the processing module 1110 is configured to set a priority automatically based on a payment card type (e.g. a titanium card may be ranked at a higher priority than a gold card) associated with the more than one issuer institutions. If all payment cards are of the same type, the processing module 1110 may be configured to pick an issuer institution at random for processing the payment transaction. In other embodiments, if it is determined that the customer identifier is associated with more than one issuer institutions and that no institution priority preference is associated with the customer identifier, the processing module 1110 may be configured to work with the communication module 1102 to transmit, to the customer electronic device 102 or the merchant server 104, a selection request requiring the customer associated with the customer electronic device 102 or the third party to select one of the issuer institutions associated with the customer identifier for processing the payment transaction. In this case, a selection response indicating at least the issuer institution is received at the processing module 1110 via the communication module 1102 in return. The selection response may also indicate the payment card associated with the customer identifier which is to be used to process the payment transaction.

The processing module 1110 may be configured to work with the query module 1106 to determine, using the payment network database 114, if the customer identifier is associated with more than one customer payment card accounts. The processing module 1110 may be configured to work with the query module 1106 to query the payment network database 114 to identify the customer payment card account associated with the customer identifier if it is determined that the customer identifier is not associated with more than one customer payment card accounts. If it is determined that the customer identifier is associated with more than one customer payment card accounts, the processing module 1110 may be configured to work with the query module 1106 to query the payment network database 114 for an account priority preference associated with the more than one customer payment card accounts, and to identify a preferred customer payment card account associated with the customer identifier for use in the payment transaction. The account priority preference may comprise ranking the customer payment card accounts in order of a preference for use in processing payment transactions. In embodiments where no account priority preference is associated with the customer identifier, or if more than one customer payment card accounts in question are set with a same ranking, the processing module 1110 is configured to set a priority automatically based on a payment card type (e.g. a titanium card may be ranked at a higher priority than a gold card) associated with the customer payment card accounts. If all payment cards associated with the customer identifier are of the same card type, the processing module 1110 may be configured to pick a customer payment card account associated with the customer identifier at random. In other embodiments, where the customer identifier is associated with more than one customer payment card account and that no account priority preference is associated with the customer identifier, the processing module 1110 is configured to work with the communication module 1102 to transmit, to the customer electronic device 102 or the merchant server 104, an account selection request requiring the customer associated with the customer electronic device 102 or the third party to select one of the customer payment card accounts associated with the customer identifier for processing the payment transaction. In this case, an account selection response indicating the customer payment card account is received at the processing module 1110 via the communication module 1102 in return.

The registration module 1112 is configured to register customers with the payment network database 114 for processing payment transactions using a transaction indicator. In particular, information associated with a customer (e.g. details of a customer electronic device 102 associated with the customer, a customer identifier, details of a customer payment card account identifier etc.) may be received at the registration module 1112 and stored in the payment network database 114 when the customer register to be a party in payment transactions processed using the transaction indicator. Moreover, issuer institutions may also register with the registration module 1112 to process payment transactions using the transaction indicator with the customer identifier and the payment amount. In this case, information associating for example a customer identifier with an issuing institution and a customer identifier with a customer payment card account may be received at the registration module 1112 and stored at the payment network database 114. Information in regards to an issuer institution preference and an account preference may also be received at the registration module 1112 via the communication module 1102 from either the customer electronic device 102 or the issuer server 110, and stored at the payment network database 114. The payment network database 114 may store information associated with an institution priority preference of the more than one issuer institutions. The institution priority preference may comprise a list of the more than one issuer institutions ranked in order of preference for processing payment transactions using a transaction indictor. The payment network database 114 may store information used for determining if the customer identifier is associated with more than one customer payment card accounts for the issuer institution. The payment network database 114 may store information associated with an account priority preference of the more than one customer payment card accounts if the customer identifier is associated with more than one customer payment card accounts for the issuer institution. The account priority preference may comprise a list of the more than one customer payment card accounts ranked in order of preference for use in payment transactions using a transaction indictor. In an embodiment, a request may be received from a customer electronic device 102 associated with a customer and/or an issuer server 110 associated with an issuer institution at the payment network server 108 to register the customer and/or the issuer institution respectively with the payment network database 114. Upon receipt of the registration request, the registration module 1112 may be configured to communicate, via the communication module 1102, with the payment network database 114 to register the customer and/or the issuer institution at the payment network database 114.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. A payment network server for processing a payment transaction initiated by a third party other than a customer when the customer is not present, the server comprising at least a computer processor and a data storage device, the data storage device comprising instructions operative by the processor to: receive, from a merchant server, a payment transaction request, the payment transaction request comprising transaction details and a transaction indicator, the transaction details comprising: i. a customer identifier provided by the third party and associated with a customer for the payment transaction and ii. a payment amount;
query a payment network database associating issuer institutions with a plurality of customer identifiers to identify using the customer identifier an issuer institution and an associated issuer server;
request authorisation, from at least one of the issuer server and the customer, to proceed with the payment transaction; and
transmit, to the merchant server, a payment transaction response indicating an approval or a refusal for the payment transaction to proceed;
wherein the transaction indicator indicates that the payment transaction is to proceed using the customer identifier and the payment amount.

2. A computerised network for processing a payment transaction, the network comprising:
the payment network server of claim 1;
a customer electronic device; and
a customer wearable device, the customer wearable device being associated with the customer electronic device; and
wherein the customer wearable device is configured to disable the customer electronic device for carrying out the payment transaction if the customer wearable device is more than a pre-determined distance away from the customer electronic device.

3. The computerised network of claim 2, wherein the customer electronic device is communicatively connected to the customer wearable device, the payment network server is configured to communicate an authentication of the payment transaction to at least one of: the customer wearable device and the customer electronic device.

4. The computerised network of claim 2, wherein the pre-determined distance is determined by the customer via the customer electronic device or the customer wearable device.

5. A computer-implemented method for processing a payment transaction initiated by a third party other than a customer when the customer is not present, the method comprising:
receiving, from a merchant server, a payment transaction request, the payment transaction request comprising transaction details and a transaction indicator, the transaction details comprising: i. a customer identifier provided by the third party and associated with a customer for the payment transaction and ii. a payment amount;
querying a payment network database associating issuer institutions with a plurality of customer identifiers to identify using the customer identifier an issuer institution and an associated issuer server;
requesting authorisation, from at least one of the issuer and the customer, to proceed with the payment transaction; and
transmitting, to the merchant server, a payment transaction response indicating an approval or a refusal for the payment transaction to proceed;
wherein the transaction indicator indicates that the payment transaction can proceed using the customer identifier and the payment amount.

6. The method of claim 5 further comprising providing dummy values within the transaction details outside of the customer identifier and the payment amount.

7. The method of claim 5 further comprising:
transmitting, to a customer electronic device, an authentication request seeking an approval by the customer to authenticate the payment transaction; and
receiving, from the customer electronic device, an authentication response indicating whether the payment transaction is authenticated;
wherein the customer electronic device is identified using the customer identifier, and wherein the payment transaction proceeds if the payment transaction is authenticated.

8. The method of claim 5 further comprising:
transmitting, to the issuer server, an authorisation request seeking an approval by the issuer server to authorise the payment transaction; and
receiving, from the issuer server, an authorisation response indicating if the payment transaction is approved or refused to proceed, wherein the authorisation response indicates an approval for the payment transaction to proceed if the payment transaction is authenticated via a customer electronic device, and wherein the transaction indicator comprised in the authorisation request prompts the issuer server to seek authentication from the customer.

9. The method of claim 7, wherein the authentication response is generated based on verification using a customer authentication identifier, the customer authentication identifier is selected from one of the following: a personal identification number (PIN), a signature, a biometric identifier, a gesture, a specific voice command and a one-time password (OTP).

10. The method of claim 7, wherein the customer electronic device is associated with a customer wearable device, the customer wearable device being configured to disable the customer electronic device for carrying out a payment transaction if the customer wearable device is more than a pre-determined distance away from the customer electronic device.

11. The method of claim 10, wherein the customer electronic device is communicatively connected to the customer wearable device, authentication of the payment transaction is communicated via the customer wearable device or the customer electronic device or both.

12. The method of claim 10, wherein the pre-determined distance is determined by the customer via the customer electronic device or the customer wearable device.

13. The method of claim 5 further comprising:
determining if the customer identifier is a customer payment card account identifier; and
request authorisation from at least one of the issuer server and the customer to proceed with the payment transaction if the customer identifier is a customer payment card account identifier.

14. The method of claim 13, wherein if the customer identifier is a personal identifier other than a customer payment card account identifier, the method further comprises:
determining, using the payment network database, if the customer identifier is associated with more than one issuer institution;
querying, the payment network database, to determine if the customer identifier is associated with an institution priority preference, the institution priority preference comprises a ranked list of the more than one issuer institution for use in the payment transaction; and
identifying an issuer institution to process the payment transaction if it is determined that the customer identifier is associated with the institution priority preference.

15. The method of claim 14, wherein if the customer identifier is not associated with the institution priority preference, the method further comprises:
transmitting, to the customer electronic device or the merchant server, a selection request requiring the customer or the third party to select one of the issuer institutions associated with the customer identifier for processing the payment transaction if the customer identifier is associated with more than one issuer institution; and
receiving, from the customer electronic device or the merchant server, a selection response indicating the issuer institution for processing the payment transaction.

16. The method of claim 13, the method further comprises:
determining, using the payment network database, if the customer identifier is associated with more than one customer payment card account, each of the customer payment card accounts being maintained by the issuer institution;
querying the payment network database to identify the customer payment card account associated with the customer identifier if it is determined that the customer identifier is not associated with more than one customer payment card account; and
request authorisation from at least one of the issuer server and the customer to proceed with the payment transaction.

17. The method of claim 16, wherein if the customer identifier is associated with more than one customer payment card accounts, the method further comprises:
querying, the payment network database, to determine if the customer identifier is associated with an account priority preference, the account priority preference comprises a ranked list of customer payment card accounts associated with the customer identifier; and
identifying a customer payment card account for use in the payment transaction if it is determined that the customer identifier is associated with the account priority preference.

18. The method of claim 17, wherein if the customer identifier is not associated with the account priority preference, the method further comprises:
transmitting, to the customer electronic device or the merchant server, an account selection request requiring the customer or the third party to select one of the customer payment card accounts associated with the customer identifier for processing the payment transaction; and
receiving, from the customer electronic device or the merchant server, an account selection response indicating the customer payment card account for processing the payment transaction.

19. A computer-implemented method for processing a payment transaction initiated by a third party other than a customer when the customer is not present, the method comprising:
receiving, from a merchant server, a payment transaction request initiated by the third party, the payment transaction request comprising transaction details and a transaction indicator, the transaction details comprising: i. a customer identifier provided by the third party and associated with a customer for the payment transaction and ii. a payment amount;
substituting information not comprised in the transaction details, such as a card verification code (CVC2) and a card expiry date, with dummy values;
determining, using a payment network database associating issuer institutions with a plurality of customer identifiers, if the customer identifier is a customer payment card account identifier;
determining, using the payment network database associating issuer institutions with a plurality of customer identifiers, whether the customer identifier is associated with more than one issuer institutions if the customer identifier is not a customer payment card account identifier;
querying the payment network database to identify using the customer identifier an issuer institution and an associated issuer server if the customer identifier is not associated with more than one issuer institutions;
determining, using the payment network database, whether the customer identifier is associated with more than one customer payment card accounts, each of the customer payment card accounts being maintained by the issuer institution;
querying the payment network database to identify the customer payment card account associated with the customer identifier if it is determined that the customer identifier is not associated with more than one customer payment card accounts;
transmitting, to the issuer server, an authorisation request seeking an approval by the issuer institution to authorise the transaction request, wherein the authorisation request comprises at least the transaction indicator, the customer payment card account identified using the payment network database and the payment amount;
receiving, from the issuer server, an authorisation response indicating an approval or a refusal for the payment transaction to proceed; and
transmitting, to the merchant server, a payment transaction response indicating an approval or a refusal for the payment transaction to proceed;
wherein the transaction indicator indicates that the payment transaction can proceed using the customer identifier and the payment amount;
wherein the transaction indicator comprised in the authorisation request prompts the issuer server to seek authentication from the customer via a customer electronic device to approve the payment transaction, the customer electronic device being identified using the customer identifier; and
wherein the customer electronic device is associated with a customer wearable device, the customer wearable device being configured to disable the customer electronic device for carrying out a payment transaction if the customer wearable device is more than a pre-determined distance away from the customer electronic device.
